(19) United States
(12) Patent Application Publication
(10) Pub. No.: US 2009/0218956 A1
(43) Pub. Date: Sep. 3, 2009

(54) ILLUMINATION CONTROL ASSEMBLY FOR IMPROVING DECAYING OF WHITE LIGHT EMITTING DIODE

(76) Inventors: Andy KAOH, Taipei City (TW); Shieh Hwei Lee Chen, Taipei (TW)

Correspondence Address: Andy KAOH, 235 Chung - Ho Box 8-24, Taipei, 235, TW

(21) Appl. No.: 12/039,748

(22) Filed: Feb. 29, 2008

(51) Int. Cl. H05B 37/02

(52) U.S. Cl. 315/291

(57) ABSTRACT

An illumination control assembly for decaying of a white light emitting diode comprising a light source controller for controlling the illumination of the white light emitting diode; a driving control circuit installed with an electromagnetic protection module, a pulse width modulation module, a current control unit which is connected to the light source controller for driving the white light emitting diode; and a white light emitting diode display including at least one white light emitting diode; the white light emitting diode being connected to a light source controller for controlling the illumination of the white light emitting diode and for transferring electronic signals so that the pulse width modulation module adjusts output from the current control unit to retain the illumination of the white light emitting diode with a constant value;

### FIELD OF THE INVENTION

The present invention relates to white light emitting diodes, and particularly to an illumination control assembly for improving decaying of a white light emitting diode, wherein the natural decay in the former 1000 hours in use of a white light emitting diode is controlled to has a constant value so as to avoid that the user misunderstands that the white light emitting diode is a defect one.

### BACKGROUND OF THE INVENTION

Generally, a white light emitting diode will have a decay of 30% of the original illumination as it is used through 1000 hours. Thus the user will feel that he (or she) has bought a bad white light emitting diode due to the decrement of the illumination, even it is updated with a new one.

Referring to FIG. 1, a schematic view showing the illumination of a prior art white light emitting diode. It is illustrated that the prior art white light emitting diode 100 will decay to have only 30% of the original illumination as it is used through 1000 hours. However this is the principle of the white light emitting diode without any relation to the quality of the white light emitting diode.

Thus it is known that the prior art white light emitting diode has the following defects:

1. The prior art white light emitting diode is not tested about the use of 1000 hours before selling. The illumination will decay naturally, while the user will think that the white light emitting diode is a bad one, and thus request the seller to replace a new one.

2. The prior art has no control structure about the decay of the illumination. After the white light emitting diode is used through 1000 hours, the illumination will decay with a value of 30% of the original illumination. Thus dispute will generate between the buyer and the seller.

3. The prior art white light emitting diode 40 has no margin of 5% to 30% for adjustment of illumination. After it is used for a time period, the illumination will decay naturally. When the illumination decreases, the original illumination can not be restored,

4. In use of the prior art white light emitting diode, the decay of the illumination will make some disputes between the buyer and seller.

### SUMMARY OF THE INVENTION

Accordingly, the object of the present invention is to provide an illumination control assembly for decaying of a white light emitting diode, which is especially for controlling the decay of the illumination of a white light emitting diode before being used through 1000 hours so as to avoid that the user feel that the white light emitting diode is a bad product from the manufacturing.

A further object of the present invention is to provide an illumination control assembly for decaying of a white light emitting diode, which has a setting of illumination which is 70%-95% of original illumination so that when the white light emitting diode decays, it has an adjust margin of 5% to 30% so that it can be adjusted to the setting value.

A yet object of the present invention is to provide an illumination control assembly for decaying of a white light emitting diode, in that the white light emitting diode can retain with a fixed illumination. Before selling, it has completed with a test of 1000 to 1100 continuous illumination. The decay of the illumination is in a steady state.

To achieve above object, the present invention provides an illumination control assembly for decaying of a white light emitting diode comprising: a light source controller for controlling the illumination of the white light emitting diode; a driving control circuit installed with an electromagnetic protection module, a pulse width modulation module, a current control unit which is connected to the light source controller for driving the white light emitting diode; a white light emitting diode display including at least one white light emitting diode; the white light emitting diode being connected to a light source controller for controlling the illumination of the white light emitting diode and for transferring electronic signals so that the pulse width modulation module adjusts output from the current control unit to retain the illumination of the white light emitting diode with a constant value; and the white light emitting diode is combined with the light source controller for controlling the decay of the illumination thereof; when the white light emitting diode decays in illumination, the pulse width modulation module will receive signals about the decay so as to adjust an output current of the current control unit to retain the illumination of the white light emitting diode with a constant value.

The light source controller is a light source voltage sensor for sensing an illumination of the white light emitting diode and for converting illumination of the white light emitting diode into electronic signals which are transferred to a driving control circuit so as to retain the white light emitting diode in a fixed illumination.

The light source controller is a manual switch for controlling the illumination of the white light emitting diode manually, switching signals are transferred in the driving control circuit do that the white light emitting diode retains with a constant illumination.

The electromagnetic protection module serves for filtering noise from the power source and avoiding electromagnetic interference.

The illumination of the white light emitting diode 40 has a setting value of 70%-95% of the full illumination in the manufacturing stage.

The white light emitting diode is retained with a fixed illumination after a 1000 to 1100 hour continuous lighting test; and the decay of the illumination enters into a steady state.

The various objects and advantages of the present invention will be more readily understood from the following detailed description when read in conjunction with the appended drawing.

### BRIEF DESCRIPTION OF THE DRAWINGS

FIG. 1 is a schematic view of the prior art white light emitting diode.

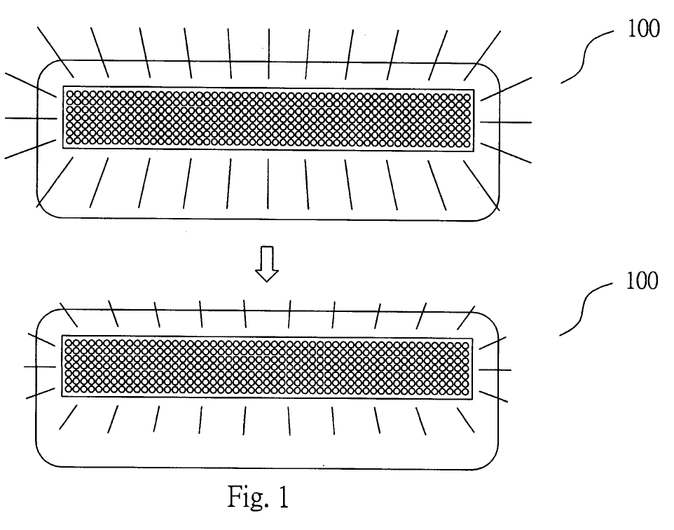

FIG. 2 shows the circuit of the present invention.

FIG. 3 shows an application of the white light emitting diode of the present invention.

FIG. 4 shows another embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

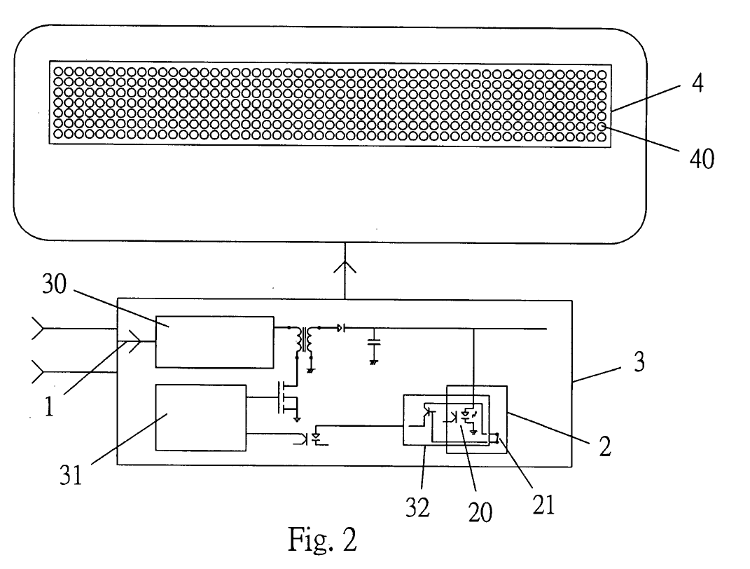

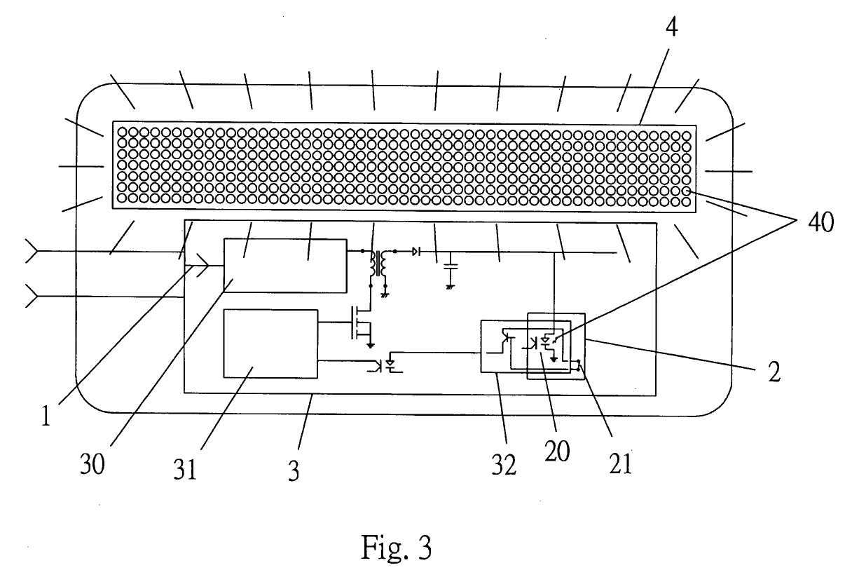

Referring to FIGS. 2 and 3, the circuits of the present invention about the embodiment of the white light emitting diode of the present invention are illustrated. The illumination control assembly for decaying of a white light emitting diode is connected to a power source 1 and has the following features.

A light source controller 2 serves for controlling the illumination of the white light emitting diode 40. The light source controller 2 is a light source voltage sensor 20 for sensing an illumination of the white light emitting diode 40 and for converting illumination of the white light emitting diode 40 into electronic signals which are transferred to a driving control circuit 3 so as to retain the white light emitting diode 40 in a fixed illumination. The light source controller 2 is a manual switch 21 for controlling the illumination of the white light emitting diode 40 manually.

A driving control circuit 3 is installed with an electromagnetic protection module 30, a pulse width modulation module 31, a current control unit 32 which is connected to the light source controller 2 for driving the white light emitting diode 40. The electromagnetic protection module 30 serves for filtering noise from the power source and avoiding electromagnetic interference.

A white light emitting diode display 4 includes at least one white light emitting diode 40. The white light emitting diode 40 is connected to a light source controller 2 for controlling the illumination of the white light emitting diode 40 and for transformation of electronic signals so that the pulse width modulation module 31 adjusts the output from the current control unit 32 to retain the illumination of the white light emitting diode 40. Before commercially used, the illumination of the white light emitting diode 40 has a setting value of 70%-95% of the full illumination as it is initially manufactured.

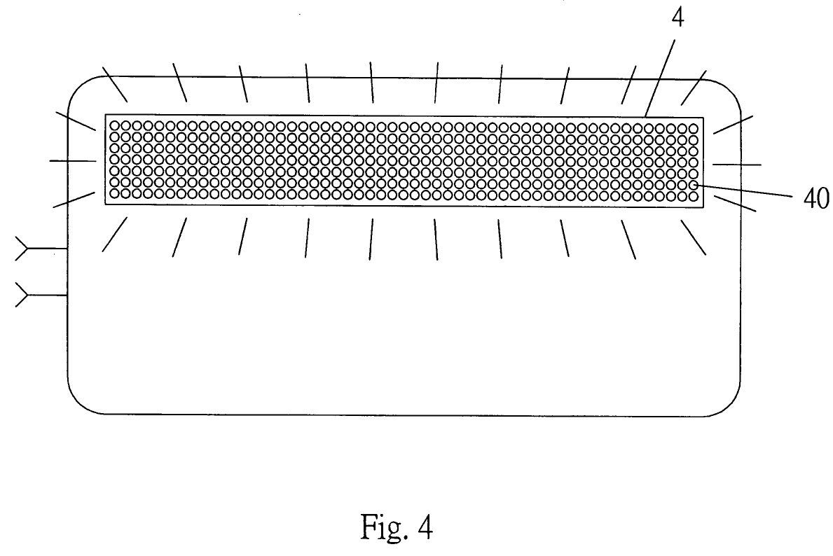

Referring to FIG. 4, another embodiment of the present invention is illustrated. As illustrated in the drawing, a white light emitting diode display 4 severs to display the illumination of the white light emitting diode 40. The white light emitting diode 40 is retained with a fixed illumination after a 1000 to 1100 hour continuous lighting test. The decay of the illumination enters into a steady state.

Advantages of the present invention will be described herein.

1. In the present invention, the manual switch serves to control the illumination of the white light emitting diode manually so that the white light emitting diode can retain with a fixed illumination.

2. The light source voltage sensor of the present invention can sense the illumination from the white light emitting diode and convert the illumination into electronic signals which is then transferred to a driving control circuit so as to adjust the illumination automatically so that the white light emitting diode can retain with a constant illumination.

3. The illumination of the white light emitting diode is set as 70% to 95% of the whole illumination in the initial manufacturing stage. Thus it has a margin of 5% to 30% for adjustment to the setting illumination to avoid dispute commercially.

4. The white light emitting diode of the present invention has made with a 1000-1100 hour continuous lighting test in the manufacturing stage so that the decay of the white light emitting diode is in a steady state without decay of the illumination.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An illumination control assembly for decaying of a white light emitting diode; the illumination control assembly being connected to a power source and comprising:
a light source controller for controlling the illumination of the white light emitting diode;
a driving control circuit installed with an electromagnetic protection module, a pulse width modulation module, a current control unit which is connected to the light source controller for driving the white light emitting diode;
a white light emitting diode display including at least one white light emitting diode; the white light emitting diode being connected to a light source controller for controlling the illumination of the white light emitting diode and for transferring electronic signals so that the pulse width modulation module adjusts output from the current control unit to retain the illumination of the white light emitting diode with a constant value;
wherein the white light emitting diode is combined with the light source controller for controlling the decay of the illumination thereof; when the white light emitting diode decays in illumination, the pulse width modulation module will receive signals about the decay so as to adjust an output current of the current control unit to retain the illumination of the white light emitting diode with a constant value.

2. The illumination control assembly for decaying of a white light emitting diode as claimed in claim 1, wherein the light source controller is a light source voltage sensor for sensing an illumination of the white light emitting diode and for converting illumination of the white light emitting diode into electronic signals which are transferred to a driving control circuit so as to retain the white light emitting diode in a fixed illumination.

3. The illumination control assembly for decaying of a white light emitting diode as claimed in claim 1, wherein the light source controller is a manual switch for controlling the illumination of the white light emitting diode manually, switching signals are transferred in the driving control circuit do that the white light emitting diode retains with a constant illumination.

4. The illumination control assembly for decaying of a white light emitting diode as claimed in claim 1, wherein the electromagnetic protection module serves for filtering noise from the power source and avoiding electromagnetic interference.

5. The illumination control assembly for decaying of a white light emitting diode as claimed in claim 1, wherein the illumination of the white light emitting diode 40 has a setting value of 70%-95% of the full illumination in the manufacturing stage.

6. The illumination control assembly for decaying of a white light emitting diode as claimed in claim 1, wherein the white light emitting diode is retained with a fixed illumination after a 1000 to 1100 hour continuous lighting test; and the decay of the illumination enters into a steady state.
